(19) United States
(12) Patent Application Publication
(10) Pub. No.: US 2015/0371553 A1
(43) Pub. Date: Dec. 24, 2015

(54) SYSTEM AND METHOD FOR PERSONALIZED NUTRITION

(71) Applicant: MyFuelUp, LLC, Gilbert, AZ (US)

(72) Inventor: Michael T. Vento, Gilbert, AZ (US)

(21) Appl. No.: 14/711,436

(22) Filed: May 13, 2015

Related U.S. Application Data
(60) Provisional application No. 62/015,882, filed on Jun. 23, 2014.

(51) Int. Cl. G09B 19/00

(52) U.S. Cl. CPC G09B 19/0092

(57) ABSTRACT

A system including a web-based application that creates a personalized diet and then communicates with a client (for example, by mobile phone) application to provide eating options, including telling a user what menu items will fit with his personalized diet at particular restaurants is disclosed. The system may also be queried if the user indicates he does not like the initial restaurant menu items. A method for providing personalized nutrition information is also disclosed.

### CROSS-REFERENCE TO RELATED APPLICATIONS

This application claims priority under 35 U.S.C. §119(e) to U.S. Provisional Application No. 62/015,882, filed on Jun. 23, 2014. These applications are incorporated by reference in their entireties. Furthermore, any and all priority claims identified in the Application Data Sheet, or any correction thereto, are hereby incorporated by reference under 37 C.F.R. §1.57.

### FIELD

The present application relates generally to personalized communications, and more specifically to systems, devices, and methods for personalized nutrition planning.

### BACKGROUND

Nutrition can be a highly complex and individualized facet of life. What works for one person may not be effective for another. The Internet has allowed the proliferation of advice, some of which can have serious adverse health consequences. Certain ways of accomplishing a fitness goal have been proven to be far superior to others (for your health and mind). But tracking the latest science and research can be a difficult process for an average person. Furthermore, not everyone has the time to invest in managing their dietary inputs to match their physical output. With the currently available technology, significant amounts of time would be needed to track, input, and process the information accurately.

### SUMMARY

In one innovative aspect, a system for providing personalized nutrition information is provided. The system may include, for example, an input interface configured to receive a plurality of input values from a client device. The system may include a memory configured to store a plurality of dietary goals, each dietary goal identifying a nutrient and a quantity for the nutrient, each dietary goal further associated with a calorie count. The system may include a diet generator. In some embodiments, the diet generator is configured to generate a candidate calorie count based on received input values. In some embodiments, the diet generator is further configured to identify a dietary goal stored in the memory based on a comparison of the candidate calorie count with the calorie count of the dietary goal. In some embodiments, the diet generator is also configured to generate the personalized nutrition information based on the identified dietary goal. In some embodiments, the system may also include a transmitter configured to provide the personalized nutrition information for display via the client device.

In some embodiments, the plurality of input values may include gender, age, height, weight, body type, physical activities, and occupation. In some embodiments, the nutrient may be a macronutrient. In some embodiments, the personalized nutrition information comprises, for example, a meal schedule.

In some implementations, a portion of the memory is configured to store reference calorie counts, reference calorie counts identifying a calorie count for a given input value. In such implementations, the diet generator is configured to generate the candidate calorie count by identifying one or more reference calorie counts stored in the memory based on the received input values.

In some implementations, the input interface includes a feedback interface configured to receive feedback input for the personalized nutrition information, such as from a client device. In such implementations, the diet generator is further configured to re-generate the candidate calorie count further based on the feedback input, re-identify the dietary goal based on the re-generated candidate calorie count, and re-generate the personalized nutrition information based on the re-generated candidate calorie count.

The input interface may include a location interface configured to receive location information identifying a physical location of the client device. In some embodiments, the memory may be configured to store nutrition information for the physical location, and wherein the personalized nutrition information comprises an item available at the physical location.

In another innovative aspect, a method of providing personalized nutrition information is provided. The method includes receiving a plurality of input values from a client device. The method includes storing, in a memory, a plurality of dietary goals, each dietary goal identifying a nutrient and a quantity for the nutrient, each dietary goal further associated with a calorie count. In some embodiments, the method further includes generating, by an electronic computing device, a candidate calorie count based on received input values. In some embodiments, the method includes identifying, via the electronic computing device, a dietary goal stored in the memory based on a comparison of the candidate calorie count with the calorie count of the dietary goal. In some embodiments, the method includes generating, via the electronic computing device, the personalized nutrition information based on the identified dietary goal. In some embodiments, the method includes providing, via the electronic computing device, the personalized nutrition information for display via the client device.

In some embodiments, the method may further include one or more of: receiving feedback input for the personalized nutrition information, re-generating the candidate calorie count further based on the feedback input, re-identifying the dietary goal based on the re-generated candidate calorie count, and re-generating the personalized nutrition information based on the re-generated candidate calorie count, or a combination thereof.

In some embodiments, the method may also include one or more of: storing nutrition information for a physical location, receiving, from the client device, location information indicating the client device is located at the physical location, wherein generating the personalized nutrition information comprises identifying an item available at the physical location, the item satisfying the identified dietary goal, or a combination thereof.

In a further innovative aspect, a computer readable medium (for example, non-transitory) having stored thereon instructions which when executed perform any of the innovative methods described is provided.

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include, among other things, efficient provisioning of personalized nutrition information and personalized nutrition planning.

### BRIEF DESCRIPTION OF THE DRAWINGS

The accompanying drawings, together with the specification, illustrate exemplary embodiments, and, together with the description, serve to explain the principles of the present disclosure.

FIG. 1 shows network diagram of an example of a personalized nutrition system.

FIG. 2 shows a functional block diagram of an exemplary personalized nutrition system client.

FIG. 3 shows a messaging diagram for an implementation of an exemplary personalized nutrition system.

FIG. 4 shows a functional block diagram of an exemplary coaching module which may be included in a personalized nutrition module.

FIG. 5 shows a process flow diagram of an exemplary method of providing personalized nutrition information.

### DETAILED DESCRIPTION

The present disclosure generally relates to systems, devices, and methods for personalized nutrition planning.

More specifically, the features provide personalized meal-plan generation focused on rapid body re-composition combined with optimal macronutrient constitution. In short, the aspects described provide users a flexible ‘roadmap’ to achieve desired fitness goals in a healthy and fulfilling manner.

In one aspect, a system including a web-based application that creates a personalized diet is provided. The application is further configured to communicate with a client application to provide eating options, including telling a user what menu items will fit with his personalized diet at particular restaurants. The system may also be queried if the user indicates he does not like the initial restaurant menu items.

One non-limiting advantage of the described features is the automatic generation of a personalized nutrition plan which can then be adjusted based on user feedback. Unlike other systems which require users to have substantial nutritional training and/or laboriously enter volumes of data, the system is based on basic inputs that most users know (for example, age, weight). From these basic inputs, the expert system tailors a nutritionally sound plan for an individual which serves as a starting point for making healthy decisions. This lowers the barriers of entry to healthier choices.

A further non-limiting advantage of the described features is the lowering of these barriers independent of the user's location. For example, the nutrition plan considers where the user is when a meal choice is to be made. In one implementation, a physical location indicator may be provided to the system. Based on the location indicator, food options (for example, restaurant, menu item) can be suggested which fall within the user's nutritional plan.

A further non-limiting advantage of the described features is dynamic and personalized grocery list generation. The list may be generated by the system based on an individual's dietary and time constraints. As discussed, each person may have different nutritional needs. Each person may further have different quantities of time to shop. As such, the system may receive user inputs indicating when and how often shopping happens. This allows the system to dynamically generate the list to suit the number of days between shopping trips. The system may be configured to monitor shopping habits and, over time, predict the amount of menu items needed for an average week for the user.

Other non-limiting advantages include user discovery of find alternative meals, that fall within dietary constraints (different from restaurant). They may specify if items should be easily placed in a blender or are portable. This enables them to deviate from the plan using combinations of foods they may have available to them. Users also may select recipes submitted by chefs that fall within their dietary plan as substitute for a given meal, when they have adequate time to prepare such a recipe. Recipe ingredients, in appropriate quantities, are automatically transferred to the grocery list. Users may also be able to personalized based on their family or household relationships. For example, a user may, via the system, ‘link’ plans (e.g., family members or roommates for instance) and specify if certain meals will be eaten together, ensuring the same items are chosen for each individual for the specified meal(s). Grocery lists may then be combined and also, in some implementations, appended to accommodate children.

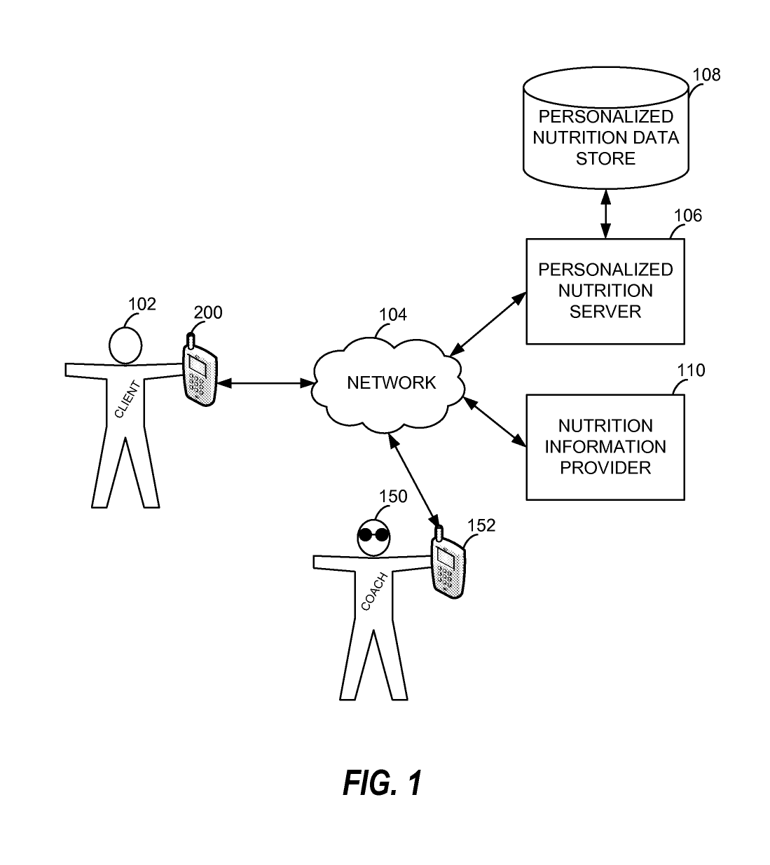

FIG. 1 shows network diagram of an example of a personalized nutrition system. A network 104 allows a client 102 using an electronic communication device 200 to access the personalized nutrition server 106. The network 104 also allows a coach 150 using an electronic communication device 152 to access the personalized nutrition server 106. The coach 150 may be a physical trainer or other service provider tracking the nutrition of the client 102. By allowing the coach 150 to collaborate with the client 102 via the personalized nutrition server 106, the nutrition plan for the client may be further tailored to the regime followed by the coach 150. The electronic communication device 200 or the electronic communication device 152 may be configured as a client device or application executing on the client device 200 to access the personalized nutrition server 106. The network 104 may include one or more cellular network, a data network, a local area network, a wide area network, a mesh network, the Internet, public switched telephone network, private network, satellite network, and/or other network suitable for communicating data. Examples of communication devices may include smartphones, tablet computers, laptop computers, personal computers, televisions, set top boxes, personal digital assistants, and game consoles.

The personalized nutrition server 106 is configured to receive inputs from the electronic communication device 200 and provide personalized nutrition information to the electronic communication device 200 based, at least in part, on the received inputs. The inputs may be stored in a personalized nutrition data store 108. The personalized nutrition data store 108 may further store information associated with a nutrition information provider 110. The information may include access information to allow the personalized nutrition server 106 to access nutrition information (for example, menus, locations, caloric information, physical activities, etc.) provided by the nutrition information provider 110. The personalized nutrition data store 108 may be configured to persist information received from the nutrition information provider 110. Nutrition information providers may include one or more of restaurants, food manufacturers, food suppliers, grocers, farmers, government agencies, weight loss assistance companies, web-sites, blogs, social media, and the like.

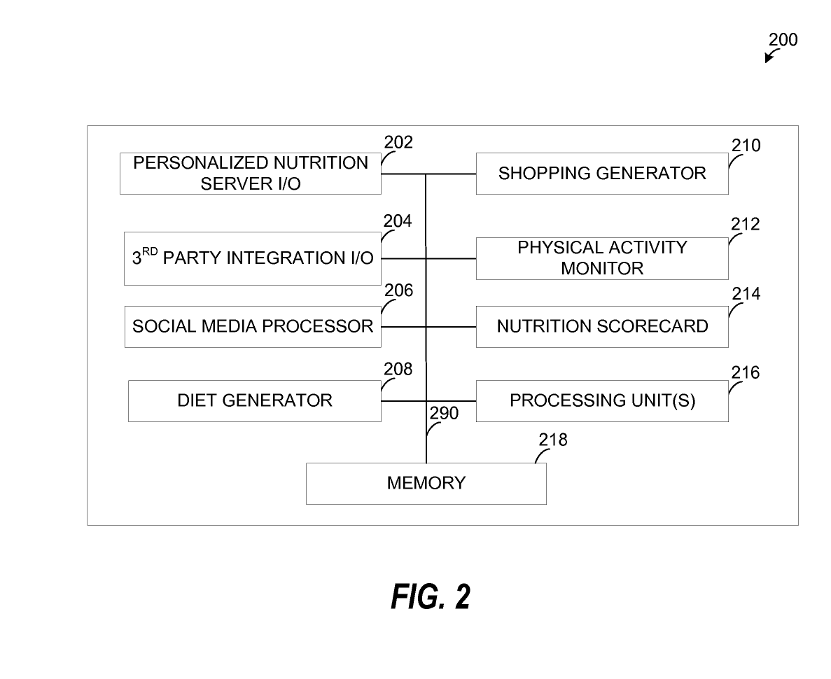

FIG. 2 shows a functional block diagram of an exemplary personalized nutrition system client. The personalized nutrition system client 200 shown in FIG. 2 includes a personalized nutrition server input/output (I/O) 202. The personalized nutrition server input/output (I/O) 202 is configured to transmit messages to and receive messages from a personalized nutrition server, such as the personalized nutrition server 106. One or more interfaces may be included in the personalized nutrition server input/output (I/O) 202 to transmit or receive specific data. Transmitting the messages may include formatting input values into a machine readable format and sending the message via a transport means. The transport means may include any data communication means such as radio, digital network packet, fiber optic packet, or the like. Receiving the messages may include decoding data from the personalized nutrition server, identifying one or more values included in the decoded data, and providing the values for further processing consistent with the features described herein. The personalized nutrition server I/O 202 may be configured for wired, wireless, or hybrid input/output.

The personalized nutrition system client 200 shown in FIG. 2 includes a third party integration I/O 204. The third party integration I/O 204 is configured to allow the client 200 to interact with third parties such as social media websites, nutrition information provider network locations, retailers, and the like. Interactions may include posting information to a third party (for example, status update) and retrieving information from a third party (for example, friend list, activities, nutrition data). The third party integration I/O 204 may be configured for wired, wireless, or hybrid input/output.

Social media information obtained via the third party integration I/O 204 may be provided to a social media processor 206. The social media processor 206 is configured to parse information obtained from social media and provide it for further processing by the client 200. For example, the social media processor 206 may obtain the activities of a user as posted on a social media site. The social media processor 206 may be configured to analyze the activities for information related to meals or exercise the user may have encountered. The analysis may be based on textual filters (for example, keywords), image recognition, geo-tagged information associated with an activity, or other information provided by the social media site.

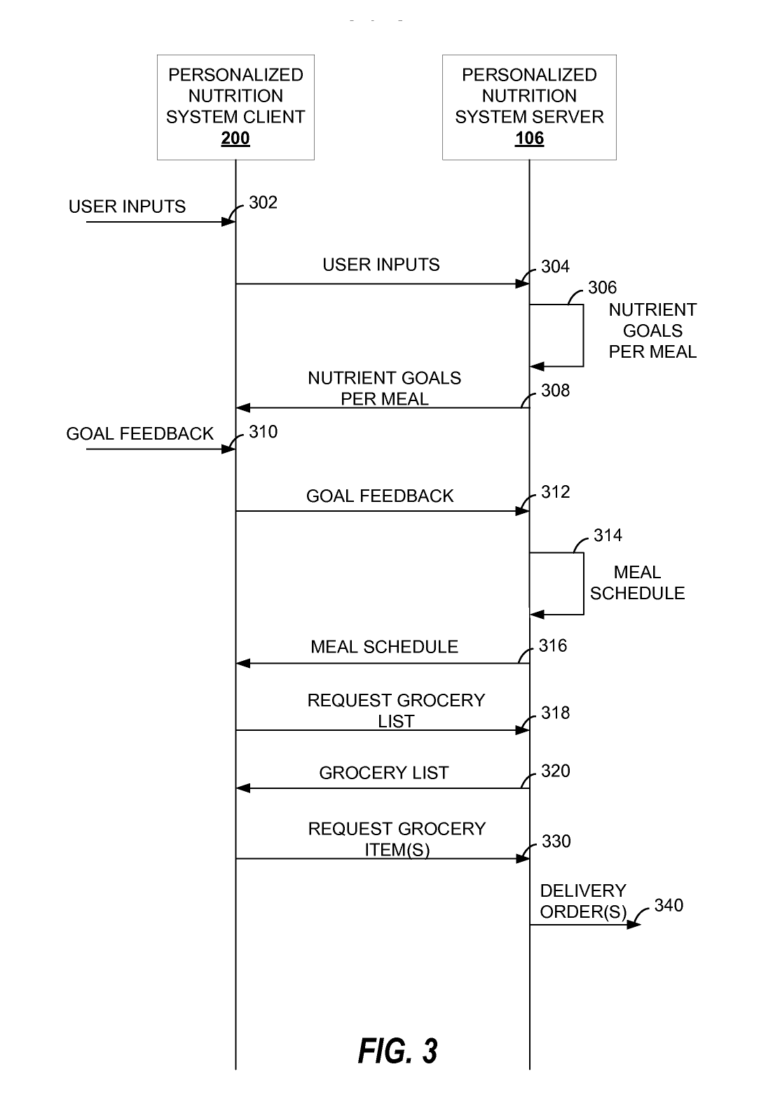

The client 200 may include a diet generator 208. The diet generator 208 is configured to present diet information for display and receive inputs for generating a diet (for example, menu). The diet generator 208 may be configured to receive inputs via user inputs (for example, height, weight), via sensors included in the device (for example, GPS, camera, accelerometer), via sensors in data communication with the device (for example, Bluetooth™ heart monitor), or via the network 104 from service providers for the device (for example, cellular provider, network provider). The diet generator 208 may then transmit the inputs to the personalized nutrition server via the personalized nutrition server I/O 202 and receive a suggested diet. The diet generator 208 may be further configured to present the suggested diet and obtain user feedback on the suggestion. This process is described in further detail below, such as in reference to FIG. 3. The diet may be stored in a memory 218.

Based on the suggested diet, a shopping generator 210 may be configured to generate a list of items for display to the user. The shopping generator 210 may be configured to receive inputs to refine the list of items. For example, the shopping generator 210 may provide eating options, including telling a user what menu items will fit with his personalized diet at particular restaurants. The shopping generator 210 may be configured to obtain feedback indicating the user does not like the initial suggested restaurant menu items. As with the diet generator 208, the shopping generator 210 may be configured to receive inputs via user inputs (for example, height, weight), via sensors included in the device (for example, GPS, camera, accelerometer), via sensors in data communication with the device (for example, Bluetooth™ heart monitor), or via the network 104 from service providers for the device (for example, cellular provider, network provider). The list of items may be stored in the memory 218.

The shopping generator 210 may be configured to provide targeted point-of-sale advertisements or promotions (for example, coupons). The advertisements or promotions may be based on the items included in the shopping list and/or the location of the device. It will be appreciated that the advertisements or promotions may be for-profit or non-profit in nature. For example, a fitness society may provide public service announcements about the benefits of good exercise habits. In some implementations the shopping generator 210 provides an interface to order one or more items. The ordering may include identifying an item and a delivery service for the item. A further discussion of the shopping list is provided below with reference to FIG. 3.

A physical activity monitor 212 may be included in the client 200. The physical activity monitor 212 is configured to receive activity information such a cardiovascular activity type, duration, and intensity. The information may be provided via user inputs (for example, height, weight), via sensors included in the device (for example, GPS, camera, accelerometer), or via sensors in data communication with the device (for example, Bluetooth™ heart monitor). In some implementations, the physical activity monitor 212 may be configured to access a database of activity types to determine the number of calories burned by an identified activity. The caloric information may be stored in the memory 218 and used to adjust the diet/menu. The physical activity monitor 212, in some implementations, is configured to provide real-time food suggestions during a workout. For example, if the physical activity monitor 212 identifies a period of activity which exceeds a predetermined threshold of time, the physical activity monitor 212 may query a database for suggested workout nutrition. The query may be local (for example, the memory 218) or to a personalized nutrition server.

Having collected diet, shopping, and activity information, the client 200 may include a nutrition scorecard 214. The nutrition scorecard 214 is configured to generate a report indicating the nutritional status for the user. For example, the report may include progress charts or trend charts illustrating weight, calories, body fat percentage, activity, etc. over time. The report may also track the adherence rate to the suggested diet/menu/shopping items. The adherence rate may be rated over a period of time. In some implementations, the adherence may be indicated via a grade (for example, A, B, C, D, F). Some individuals or organizations may participate in wellness programs. Such programs may track the information included in the report generated by the nutrition scorecard 214. As such, the nutrition scorecard 214 may be configured to transmit the report to a nutritionist, wellness program server, or the like.

The client 200 may include one or more processing units 216 which are configured to obtain instructions and data via a bus 290 from the memory 218. The processing units 216 may be implemented as a programmable logic device that performs instruction, logic, and mathematical processing, and may be representative of one or more CPUs.

The elements of the client 200 are coupled by the bus 290. The bus 290 is configured to allow the elements to exchange data and/or power. In some implementations, parallel busses may be included, one for data and one for power.

The memory 218 may include one or a combination of memory devices, including Random Access Memory, nonvolatile, backup memory (for example, programmable or Flash memories, read-only memories, etc.), networked memory (for example, cloud storage).

While multiple discrete elements are shown in FIG. 2, it will be appreciated that, in some implementations, the elements may be commonly implemented such as a combination of the diet generator 208 and the shopping generator 210.

FIG. 3 shows a messaging diagram for an implementation of an exemplary personalized nutrition system. The message diagram in FIG. 3 illustrates the messages between the personalized nutrition system client 200 and the personalized nutrition system server 106. It will be understood that the messages may be transmitted via one or more intermediaries. Examples of such intermediaries include packet network gateways, cellular access points, mirroring servers, pre-processing servers (for example, encrypting), post-processing servers (for example, decryption), and the like.

Via an interface, the personalized nutrition system client 200 receives a message 302 including user inputs. The interface may be provided to a user via a client device such the client device 200 shown in FIGS. 1 and 2. The user inputs may include one or more of gender, age, height, weight, body type, physical activities, occupation, and other information for generating an average daily caloric need (e.g., calorie count and/or type of calories) for the user.

The user inputs may be provided to the personalized nutrition system server 106 via message 304. The message 304 may include the inputs as provided to the client device 200. In some implementations, the client device 200 may aggregate the inputs and transmit the aggregated value in the message 304. For example, the client device 200 may be configured to generate a body mass index value based on gender, age, height, and weight. Similarly, the client device 200 may be configured to generate an activity factor based on the physical activities and occupation. It may be desirable, in some deployments, to send both the raw user inputs and the generated values. In implementations where the message 304 includes only raw user inputs, the personalized nutrition system server may be configured to generate the aggregated values for further processing.

The personalized nutrition system server 106 may be configured, via messaging 306, to generate nutrient goals per meal. The nutrient goals may be macronutrient goals per meal. The nutrient goals may include macromineral goals per meal. Although described at a per meal basis, the goals may be expressed in other units measuring time such as per hour, per workout, per week, or per day. The generation of nutrient goals per meal may include first identifying nutrients from a set of nutrients based on the user inputs. For example, some nutrients are useful for active individuals having an “ideal” body mass. Other individuals who are more sedentary and may have a body mass greater than the “ideal” for those similarly situated may require an alternative set of nutrients to support their activity and physical characteristics. The nutrient goals may be stored in a database such as the personalized nutrition data store 108 shown in FIG. 1. The nutrient goals may also be associated with values or ranges of values corresponding to the user input values. Based on a comparison of the user input values with the defined values associated with one or more nutrient goals, the goals may be obtained.

Message 308 delivers the nutrient goals to the personalized nutrition system client 200. The client device 106 may be configured to present the goals via a display. The client device 106 may also be configured to goal receive feedback. The goal feedback may include allergies, intolerances, lifestyle (for example, vegan, vegetarian, paleo), supplement schedule, shopping habits (for example, organic, eat-out, store preference), and linked accounts (for example, spouse, partner, coach, co-worker). The goal feedback may include user overrides. For example, a user may require a higher or lower number of calories. This user override may be used in place of information generated by the personalized nutrition system server 106 such as the average daily caloric need.

The goal feedback 310 may be provided to the personalized nutrition system server 106 via the message 312. The message 312 may include the goal feedback as provided to the client device 200. In some implementations, the client device 200 may aggregate the goal feedback and transmit the aggregated values in the message 312. For example, the client device 200 may be configured to regenerate the nutrient goals per meal based off the goal feedback user override. Similarly, the client device 200 may be configured to generate a list of food types based off the user's allergies, lifestyle, and shopping habits. It may be desirable, in some deployments, to send both the raw goal feedback and the generated values. In implementations where the message 312 includes only raw goal feedback, the personalized nutrition system server may be configured to generate the aggregated values for further processing. The goal feedback may be stored in a database such as the personalized nutrition data store 108 shown in FIG. 1.

The personalized nutrition system server 106 may be configured, via messaging 314, to generate a meal schedule. Although described at a per meal basis, the meal schedule may be expressed in other units measuring time such as per hour, per workout, per week, or per day. The generation of the meal schedule may include first identifying food types that are appropriate for a user based on the nutrient goals and the goal feedback. For example, active individuals with food allergies, who eat a vegan diet, and buy organic food, may require a restrictive set of food types to support their activity level, lifestyle, and shopping habits. However, an active individual without food allergies, who eats an omnivorous diet, and does not buy organic food, may require a less restrictive set of food types to support their activity level, lifestyle, and shopping habits. The food types may be stored in a database such as the personalized nutrition data store 108 shown in FIG. 1. Based on a comparison of the nutrient goals, the goal feedback, and the food types, the meal schedule may be obtained.

The message 316 delivers the meal schedule to the personalized nutrition system client 200. The client device 106 may be configured to present the meal schedule via a display. The client device 106 may also be configured to receive meal schedule feedback (not shown). The meal schedule feedback may include user meal overrides. For example, a user may require different types of food, different quantities of foods, or different frequencies of meals. The user meal override may be used in place of information generated by the personalized nutrition system server 106 such as the meal schedule. The user meal override may require additional sending and receiving of messages between the personalized nutrition system client 200 and the personalized nutrition system server 106.

The personalized nutrition system client 200 may send message 318 to the personalized nutrition system server 106 requesting a grocery list for one or more meal plans spanning one or more timeframes. A timeframe may be expressed in hours, days, weeks, or months. In one implementation, the personalized nutrition system server 106 is configured to access the personalized nutrition system data store to generate the grocery list. The list is generated in part based on the meal schedule. In some implementations, incentives may be included as part of the list generation. For example, a meal schedule may call for may include turkey. Gobble-gobble Brand Turkey may be a paid sponsor of the system and, when the grocery list is generated, rather than simply listing “turkey” the list may include “Gobble-gobble Brand Turkey.” It may be desirable to include an indicator that a given list item is a sponsored list item to highlight where equivalent substitutes may be included. The grocery list may be generally applied to account for items of food to be consumed. As such, the grocery list may include menu items for a restaurant. The grocery list is generated by the system based on, for example, the number of each day-type the user specifies that they are shopping for.

The message 320 delivers the grocery list to the personalized nutrition system client 200. The client device 200 may be configured to present the grocery list via a display. The client device 200 may be configured to provide the user with one or more interfaces for interacting with the grocery list. For example, the user may be able to print or email their grocery list using an interface provided by the personalized nutrition system client 200. In some implementations, the user may be able to order delivery service of their grocery list. In the example shown in FIG. 3, the personalized nutrition system client 200 may send a message 330 requesting food delivery of one or more items included on the grocery list to the personalized nutrition system server 106. The personalized nutrition system server 106 may then send delivery orders 340 to one or more a third party food delivery companies (not shown) to fulfill the requested items.

It will be appreciated that the messaging 312 through 320 may be iteratively performed. For example, goal feedback may include a location for the user. The personalized nutrition system server 106 may dynamically adjust the meal schedule to account for the foods available at the specified location. In such implementations, the personalized nutrition data store 108 may include geotagged information which can be used as a further basis for generating the meal schedule. For example, when submitting feedback, spatial position information can be included such that the plan is generated to satisfy not only the nutritional needs of the user, but also within a specified location. The location may be specified as a restaurant or grocery store, for example. The location may be specified as a point-radius, such as any food source within walking distance of a location. In some implementations, personalized nutrition data store 108 may include a directory of providers from which the personalized nutrition system server 106 can discover options. The directory of providers may be geotagged to provide location specific sources of food. This implementation may be desirable to reduce the amount of individual food items stored in the personalized nutrition data store 108. It will be appreciated that an intermediate solution may be provided whereby the directory of geotagged providers is included in the data store along with general categories of items available from the provider. In such implementations, the personalized nutrition system server 106 may identify a list of possible sources for the user's location and then query the possible sources to discover specific items that meet the user's nutritional plan.

The goal feedback may include foods actually consumed for a given meal. In response to receiving location or feedback information, the personalized nutrition system server 106 may dynamically adjust the meal schedule to account for nutrients consumed (or not consumed) according to the schedule, feedback, location, etc. The adjustments may include deleting an item from a later scheduled meal or adding an item to a later scheduled meal.

FIG. 3 illustrates one implementation of how a diet survey for an individual may be conducted. Based on user inputs such as gender, age, height, weight, body-type, workout type, type of job (for example, ‘activity level’), workout timing, allergies/intolerances, lifestyle, and grocery shopping habits (cost/organic/farming preferences) a plan may be tailored to the user's needs. The plan considers not just what to consume, but when to consume it. Timing can be very important. Accordingly, the time of workout, working hours, meal times, etc. may be considered in generating the diet. Furthermore, the time may be used to provide reminders to the user regarding not just what to eat or which supplement to take, but when. Additional user input may be received to link accounts for family members/partners and accounting for age (for example, children) may be desirable in some implementations.

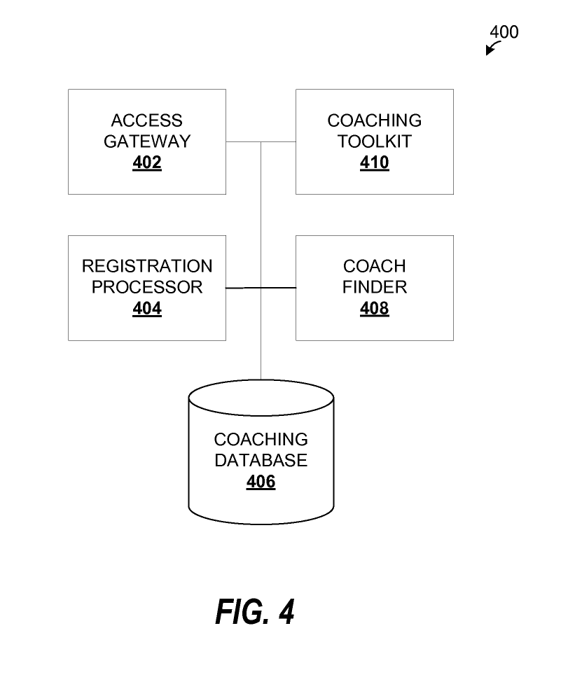

FIG. 4 shows a functional block diagram of an exemplary coaching module which may be included in a personalized nutrition module. The coaching module 400 may be included one or more of the personalized nutrition systems described herein, such as that shown in FIG. 1.

The coaching module 400 may be included to allow coaches to work with clients to provide personalized nutrition information. For example, a personal trainer may utilize the system to generate a diet plan for a client based on the client's input information, the personal trainer's training plan for the client, and the intelligence included in the system.

The coaching module 400 may include an access gateway 402. The access gateway 402 is configured to receive access information from a client device and determine whether to allow access to various functions of the coaching module 400 based on the received access information. The access information may include one or more of an access key, a promotional key, authentication information, authorization information, and the like. In general, the access information will be provided by a coach wishing to access the system. In some implementations, the access gateway 402 may be configured to provide access information. For example, the access gateway 402 may be configured to provide a sign-up interface to receive the coach's information and, in some implementation, payment information. The access gateway 402 may process the information provided via the sign-up interface to determine whether to provide access information for the identified user.

The coaching module 400 may include a registration processor 404. The registration processor 404 is configured to receive registration information from users granted access to the system by the access gateway 402. If a user is accessing the system for the first time, the registration processor 404 may be configured to provide one or more interfaces to obtain registration information about the user. The registration information collected may be stored in association with the user's account. The coaching module 400 may include a coaching database 406 configured to store the registration information. The registration information may include the coach's gender, geographic location, specialty, personal narrative, certifications, contact information (for example, phone number, email address, web address, fax) and the like.

The coaching module 400 may include a coach finder 408. The coach finder is configured to receive input information from a client device. In general, a client user wishing to search for a coach will provide the input information to the client device. The coach finder 408 may be configured to provide one or more interfaces for a client device to collect the input information. The input information collected may be stored in association with the client user's account. The input information may include one or more of a country, a state, a province, a zip code, a county, a street address, a set of latitude and longitude coordinates, an Internet Protocol address, a geographic location search radius, a gender, a specialty, a certification, a popularity rating, a price range, an availability date, and the like. The specialties may include physical training, health and wellness training, nutritional training, and the like.

The coach finder 408 is configured to query the coaching database 406 for coach users that match the input information. The query may include none, some, or all of a client user's input information. For example, the coach finder 408 may search the coaching database 406 for coach users based on their specialties, certifications, gender, popularity, price, availability, geographic location, and the like. In some implementations, the coach finder 408 may be configured to query the coaching database using previously stored input information. After a query, the coaching database 406 is configured to return a coach result set that may be comprised of matched coach user profiles.

The coach finder 408 is configured to output the coach result set to a client device. The coach finder 408 may be configured to provide one or more interfaces, to a client device, for a client user to interact with the coach result set. In some implementations, the coach finder 408 may be configured to allow a client user to perform additional searches within the coach result set. The coach finder 408 may also be configured to provide one or more contact interfaces enabling a client user to contact coach users contained within the coach result set. The contact interfaces may include interfaces for sending messages to a coach user's coaching tool kit 410, sending emails to a coach user's email address, sending text messages to a coach user, calling a coach user's telephone, hiring a coach user, and the like.

The coaching module 400 may include a coaching took kit 410. The coaching toolkit 410 is configured to search the coaching database 406 for one or more client users and then send the client result set, comprising of client information, to a coach user's client device. The coaching toolkit 410 may be configured to provide one or more interfaces for a client device to receive the client information from the coaching toolkit 410. The client information may include one or more of a client user's diet plans and performance, workout plans and performance, messages to their coach, contact information, health statistics, and the like. In some implementations, the coaching toolkit may be configured as a paid feature.

The coaching toolkit 410 is also configured to receive training information from a client device. The coaching toolkit 410 may be configured to provide one or more interfaces for a client device to send training information to the coaching toolkit 410. In general, a coach user wishing to train a client user will provide the coaching toolkit with the training information. The training information collected for a particular client user may be stored in association with either the client user's account or the coach user's account. The training information may include helpful messages, motivational messages, suggested changes to a client user's diet plans, and the like. In some implementations, the coaching toolkit may be configured to manage a client user's workout plans. For example, a coach user could make edits to a client user's workout plans or add new workout plans via the coaching toolkit 410.

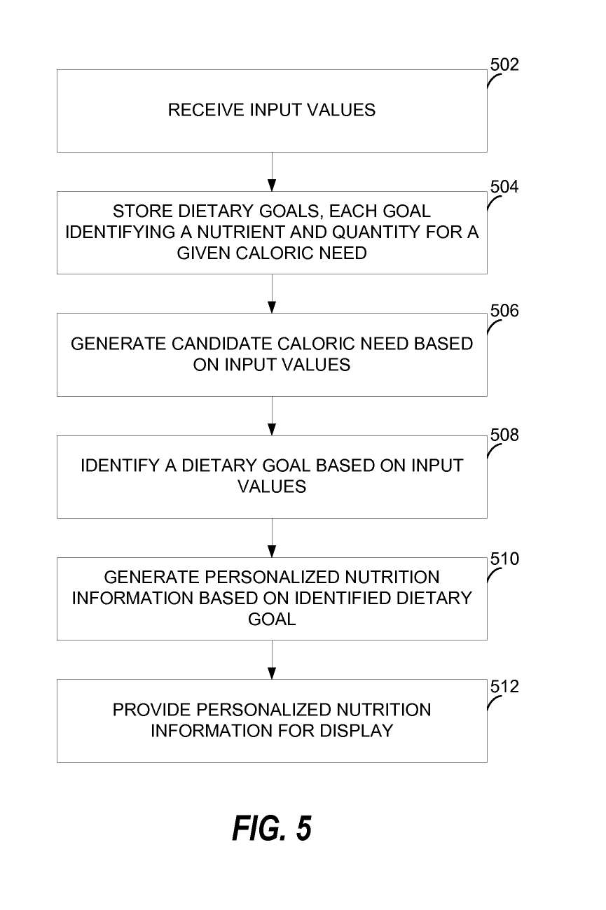

FIG. 5 shows a process flow diagram of an exemplary method of providing personalized nutrition information. The method may be performed by one or more of the devices described herein such as the personalized nutrition server 106. At node 502, a plurality of input values are received from a client device. At node 504, a plurality of dietary goals are stored in a memory. Each dietary goal identifies a nutrient and a quantity for the nutrient. Each dietary goal is further associated with a caloric need. At node 506, a candidate caloric need based on received input values is generated by an electronic computing device. At node 508, a dietary goal stored in the memory is identified via the electronic computing device. The identification is based on a comparison of the candidate caloric need with the caloric need of the dietary goal. At node 510, the personalized nutrition information is generated, via the electronic computing device, based on the identified dietary goal. At node 512, via the electronic computing device, the personalized nutrition information is provided for display via the client device.

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art may appreciate that the scope of the disclosure is intended to cover any aspect of the novel systems, apparatuses, and methods disclosed herein, whether implemented independently of, or combined with, any other aspect described. For example, an apparatus may be implemented or a method may be practiced using any number of the aspects set forth herein. In addition, the scope of the described features is intended to cover such an apparatus or method which is practiced using other structure, functionality, or structure and functionality in addition to or other than the various aspects of the invention set forth herein. It may be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not limited to particular benefits, uses, or objectives. Rather, aspects of the disclosure are broadly applicable to different personalization technologies, system configurations, networks, and transmission protocols, some of which are illustrated by way of example in the figures and the included description of the preferred aspects. The detailed description and drawings are merely illustrative of the disclosure rather than limiting, the scope of the disclosure being defined by the appended claims and equivalents thereof.

The terms “processor” and “processor module,” as used herein are a broad terms, and are to be given their ordinary and customary meaning to a person of ordinary skill in the art (and are not to be limited to a special or customized meaning), and refer without limitation to a computer system, state machine, processor, or the like designed to perform arithmetic or logic operations using logic circuitry that responds to and processes the basic instructions that drive a computer. In some embodiments, the terms can include ROM and/or RAM associated therewith.

As used herein, the term “determining” encompasses a wide variety of actions. For example, “determining” may include calculating, computing, processing, deriving, investigating, looking up (for example, looking up in a table, a database or another data structure), ascertaining and the like. Also, “determining” may include receiving (for example, receiving information), accessing (for example, accessing data in a memory) and the like. Also, “determining” may include resolving, selecting, choosing, establishing, and the like.

As used herein, the term “message” encompasses a wide variety of formats for representing information for transmission. A message may include a machine readable aggregation of information such as an XML document, fixed field message, comma separated message, or the like. While recited in the singular, it will be understood that a message may be composed/transmitted/stored/received/etc. in multiple parts.

As used herein a “graphical user interface” or “interface” may include a web-based interface including data fields or other control elements for receiving input signals or providing electronic information. The graphical user interface or interface may be implemented in whole or in part using technologies such as HTML, Flash, Java, .net, web services, and RSS. In some implementations, the graphical user interface or the interface may be included in a stand-alone client (for example, thick client, fat client) configured to communicate in accordance with one or more of the aspects described.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

Conditional language used herein, such as, among others, “can,” “could,” “might,” “may,” “e.g.,” “for example,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Depending on the embodiment, certain acts, events, or functions of any of the methods described herein can be performed in a different sequence, can be added, merged, or left out altogether (for example, not all described acts or events are necessary for the practice of the method). Moreover, in certain embodiments, acts or events can be performed concurrently, for example, through multi-threaded processing, interrupt processing, or multiple processors or processor cores, rather than sequentially.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such embodiment decisions should not be interpreted as causing a departure from the scope of the disclosure.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosures described herein can be embodied within a form that does not provide all of the features and benefits set forth herein, as some features can be used or practiced separately from others. The scope of certain disclosures disclosed herein is indicated by the appended claims rather than by the foregoing description. All changes which come within the meaning and range of equivalency of the claims are to be embraced within their scope.

What is claimed is:

1. A system for providing personalized nutrition information, the system comprising:
an input interface configured to receive a plurality of input values from a client device;
a feedback interface configured to receive feedback input for provided personalized nutrition information;
a location interface configured to receive location information identifying a physical location of the client device;
a memory configured to store a plurality of dietary goals, each dietary goal identifying a nutrient and a quantity for the nutrient, each dietary goal further associated with a calorie count;
a diet generator configured to:
generate a candidate calorie count based on received input values,
identify a dietary goal stored in the memory based on a comparison of the candidate calorie count with the calorie count of the dietary goal, and
generate the personalized nutrition information based on the identified dietary goal; and
a transmitter configured to, in response to generating the personalized nutritional information, transmit a computer readable message including the personalized nutrition information,
wherein a first portion of the memory is configured to store nutrition information for the physical location,
wherein the diet generator is further configured to, in response to receiving the location information, identify items available at the physical location identified by the location information, and generate second personalized nutritional information using the identified items, and
wherein the diet generator is further configured to, in response to receiving feedback input for the personalized nutrition information, generate a second candidate calorie count further based on the feedback input, identify a second dietary goal based on the second candidate calorie count, and generate third personalized nutrition information based on the second candidate calorie count.

2. A system for providing personalized nutrition information, the system comprising:
an input interface configured to receive a plurality of input values from a client device;
a memory configured to store a plurality of dietary goals, each dietary goal identifying a nutrient and a quantity for the nutrient, each dietary goal further associated with a calorie count;
a diet generator in data communication with the input interface and the memory, the diet generator configured to:
generate a candidate calorie count based on received input values,
identify a dietary goal stored in the memory based on a comparison of the candidate calorie count with the calorie count of the dietary goal; and
generate the personalized nutrition information based on the identified dietary goal; and
a transmitter in data communication with the diet generator, the transmitter configured to provide the personalized nutrition information for display via the client device.

3. The system of claim 2, wherein the plurality of input values include gender, age, height, weight, body type, physical activities, and occupation data.

4. The system of claim 2, wherein the nutrient is a macronutrient.

5. The system of claim 2, wherein a first portion of the memory is configured to store reference calorie counts, an individual reference calorie count identifying a calorie count for a given input value, and wherein the diet generator is configured to generate the candidate calorie count by identifying one or more reference calorie counts stored in the memory based on the received input values.

6. The system of claim 2, wherein the input interface includes a feedback interface configured to receive feedback input for the personalized nutrition information, and wherein the diet generator is further configured to re-generate the candidate calorie count further based on the feedback input, re-identify the dietary goal based on the re-generated candidate calorie count, and re-generate the personalized nutrition information based on the re-generated candidate calorie count.

7. The system of claim 2, wherein the personalized nutrition information comprises a meal schedule.

8. The system of claim 2, wherein the input interface includes a location interface configured to receive location information identifying a physical location of the client device, wherein a first portion of the memory is configured to store nutrition information for the physical location, and wherein the personalized nutrition information comprises an item available at the physical location.

9. A method of providing personalized nutrition information, the method comprising:
receiving a plurality of input values from a client device;
storing, in a memory, a plurality of dietary goals, each dietary goal identifying a nutrient and a quantity for the nutrient, each dietary goal further associated with a calorie count;
generating, by an electronic computing device, a candidate calorie count based on received input values;
identifying, via the electronic computing device, a dietary goal stored in the memory based on a comparison of the candidate calorie count with the calorie count of the dietary goal;
generating, via the electronic computing device, the personalized nutrition information based on the identified dietary goal; and
providing, via the electronic computing device, the personalized nutrition information for display via the client device.

10. The method of claim 9, further comprising:
receiving feedback input for the personalized nutrition information;
re-generating the candidate calorie count further based on the feedback input;
re-identifying the dietary goal based on the re-generated candidate calorie count; and
re-generating the personalized nutrition information based on the re-generated candidate calorie count.

11. The method of claim 9, wherein the personalized nutrition information comprises a meal schedule.

12. The method of claim 9, further comprising:
storing nutrition information for a physical location; and
receiving, from the client device, location information indicating the client device is located at the physical location, wherein generating the personalized nutrition information comprises identifying an item available at the physical location, the item satisfying the identified dietary goal.
